(19) United States
(12) Patent Application Publication
(10) Pub. No.: US 2004/0207924 A1
(43) Pub. Date: Oct. 21, 2004

(54) Prism color separation (PCS) system for display applications

(75) Inventor: Jie Chen, Saratoga, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: XHP Microsystems, Inc., Santa Clara, CA

(21) Appl. No.: 10/756,809

(22) Filed: Jan. 12, 2004

Related U.S. Application Data
(60) Provisional application No. 60/439,343, filed on Jan. 10, 2003.

(51) Int. Cl. G02B 27/14

(52) U.S. Cl. 359/634

(57) ABSTRACT

A color separation method and system wherein an optical spectrum is separated into optical wavelength ranges and wherein the optical signals of the separated wavelength ranges are further separated temporally. The optical spectrum can be spatially dispersed and the optical signals can be temporally dispersed, with three optical signals representing primary colors, such as red, green and blue.

### CROSS-REFERENCES TO RELATED APPLICATIONS

This non-provisional application claims priority to U.S. provisional application Serial No. 60/439,343 filed Jan. 10, 2003. This provisional patent application is incorporated by reference herein for all purposes.

### BACKGROUND OF THE INVENTION

The present invention relates generally to optics. More particularly, the invention provides a method and structure for fabricating and controlling a color separation system. Merely by way of example, the invention has been applied to a color separation system featuring a set of optical prisms and a partially opaque rotating disc. The method and structure can be applied to other applications as well, such as digital printers, digital imaging, 3D imaging, and the like.

Color displays typically utilize the three primary colors, red, green, and blue (RGB) to display a wide range of color combinations. Depending on the display system, colors have usually been generated using phosphors (for cathode ray tubes (CRT) and field emission displays (FED)), color filters (for liquid crystal displays (LCD) and digital light projectors (DLP)), and semiconductor diodes and lasers (for light emitting diode (LED) and grating light valve (GLV) displays). For time-modulated color displays, it is usually desirable to maximize optical throughput efficiency, as a single pixel of the display is used to display all three colors for the given pixel. Color filters are often used to perform color separation in time-modulated displays.

Time-modulated displays are sometimes referred to as “field sequential” color displays because the different colors are presented in sequence, rather than simultaneously. A drawback of color filter systems is that a significant percentage of the optical energy may be discarded at the color filter during the process of color separation. FIG. 1 is a simplified schematic illustration of the temporal and spectral characteristics of light produced by a conventional color wheel. As illustrated in FIG. 1, when the red portion 120 of the color wheel 105 is aligned with the illumination source 110, only the red portion of the spectrum is passed, represented by the cross-hatched box 130 under the letter R in the wavelength versus time graph. The green and blue portions of the optical spectrum, represented by the clear boxes under the letter R, are blocked, and therefore wasted. Similar optical throughput losses are experienced when the green and blue portions of the spectrum are passed by the color wheel. The limited portion of the spectrum passed by the color wheels during these later times are represented by the cross-hatched boxes under the letters G and B. Therefore, there is a need in the art for an improved color separation system.

These and other objects and features of the present invention and the manner of obtaining them will become apparent to those skilled in the art, and the invention itself will be best understood by reference to the following detailed description read in conjunction with the accompanying drawings.

### SUMMARY OF THE INVENTION

According to the invention, a method and apparatus are provided for controlling color separation wherein an optical spectrum is separated into optical wavelength ranges and wherein the optical signals of the separated wavelength ranges are further separated temporally. Merely by way of example, the invention has been applied to a color separation system featuring a set of optical prisms and a partially opaque rotating disc. The method and structure can be applied to other applications as well such as digital printers, digital imaging, 3D imaging, and the like.

In a specific embodiment, a color separation system for generating optical signals for display applications employs an optical illumination source that generates an optical beam, a first optically refractive element to refract the optical beam to produce an optical spectrum, a selection mechanism operative to separate the optical spectrum into at least a first optical signal of a first predetermined wavelength range and a second optical signal of a second predetermined wavelength range, and a second optically refractive element which is operative to temporally separate the first optical signal from the second optical signal. More specifically, the optical spectrum can be spatially dispersed, and the optical signals can be temporally dispersed, with three optical signals representing primary colors such as red, green and blue.

Applications of color separation systems according to embodiments of the present invention include components for front and rear projection display systems. Additionally, components for digital printing and digital imaging systems are other potential application areas. As will be evident to those skilled in the art, use of a color separation system in accordance with the present invention is not limited to the several applications discussed above.

Numerous benefits are achieved using the present invention over conventional techniques. For example, in an embodiment according to the present invention, the percentage of optical energy generated for a given optical source is greater than with conventional color wheels. Additionally, color separation systems according to embodiments of the present invention provide greater control over the number and wavelength coverage of primary colors than conventional systems. Depending upon the embodiment, one or more of these benefits may exist. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified schematic illustration of the temporal and spectral characteristics of light produced by a conventional color wheel.

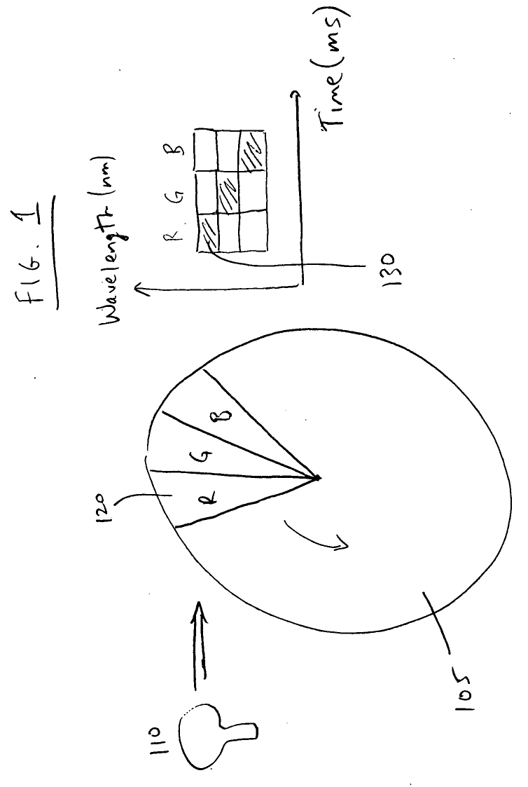

FIG. 2 is a simplified schematic diagram of a color separation system according to an embodiment of the present invention.

FIG. 3 is a simplified schematic diagram of a wavelength selector disc in accordance with an embodiment according to the present invention.

FIG. 4 is a simplified schematic diagram of a wavelength selector disc according to an alternative embodiment of the present invention.

### DETAILED DESCRIPTION OF THE INVENTION

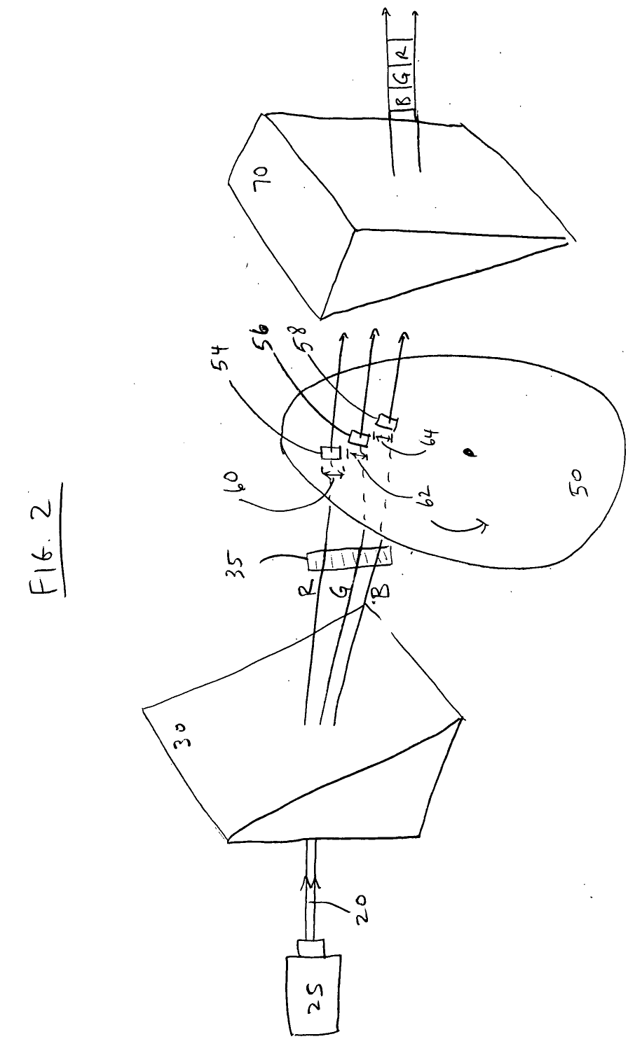

FIG. 2 is a simplified schematic diagram of a color separation system according to an embodiment of the present invention. A beam of light 20 generated by optical radiation source 25 impinges on a first prism 30. As the beam of light passes through the first prism, the beam is refracted to generate an optical spectrum 35. The optical spectrum illustrated in FIG. 2 has the longer wavelength (red) portion of the spectrum at the upper end of the spectrum. Shorter wavelength (blue) portions of the spectrum appear at the lower end of the spectrum.

After the optical beam has been dispersed by the prism in FIG. 2, color selector disc 50 is utilized to divide the optical energy into wavelength bands. As illustrated in FIG. 2, the color selector disc can be formed from any suitable material. In the embodiment according to the present invention illustrated in FIG. 2, the color selector disc is formed from an optically opaque disc in which transparent openings 54, 56, and 58 have been machined. In alternative embodiments according to the present invention, the color selector is made from an optically transparent disc on which optically absorbing or reflective material has been preferentially deposited. As illustrated in FIG. 2, the color selector disc is rotated in a CCW direction at a predetermined frequency. In a specific embodiment according to the present invention, the color selector disc is rotated at a frequency of several to several hundred Hz.

The position and size of the transparent openings 54, 56, and 58 are selected so that they are located at predetermined positions and have predetermined sizes. In a specific embodiment according to the present invention, transparent opening 54 is located at a position such that the opening will be aligned with the red portion of the optical spectrum 35. In the embodiment according to the present invention illustrated in FIG. 2, the vertical height 60 of the transparent opening 54 is chosen to overlap the spectrum over the range from 600-700 nm. In this embodiment, the red portion of the spectrum passes through the transparent opening 54 when the color selector is rotated to align the transparent opening 54 with the spectrum 35.

The transparent openings 56 and 58 in the color selector are also selected so that they are located at predetermined positions and have predetermined sizes. In the embodiment according to the present invention illustrated in FIG. 2, transparent opening 56 is fabricated so that the vertical height 62 of the transparent opening 56 overlaps with the green portion of the spectrum from 500-600 nm. Furthermore, in this embodiment, transparent opening 58 is fabricated so that the vertical height 64 of the transparent opening 58 overlaps with the blue portion of the spectrum from 400-500 nm.

As will be evident to one of skill in the art, the vertical height of the transparent openings 54, 56, and 58 will determine the range of wavelengths passed through the respective opening. In the embodiment illustrated in FIG. 2, the wavelength ranges are adjacent each other, but this is not required by the present invention. In alternative embodiments in accordance with the present invention, the transparent openings are fabricated to select only certain portions of the optical spectrum, discarding radiation outside the selected portions. In yet another alternative embodiment, the transparent openings are fabricated to overlap vertically, passing the same wavelength through multiple openings. Thus, in this embodiment according to the present invention, the vertical height of the various transparent openings determines the wavelength range passed by the color selector as a function of rotation angle.

As illustrated in FIG. 2, the transparent openings 54, 56, and 58 are offset from each other at an angle. As will be evident to one of skill in the art, this angular offset will compensate for the different propagation velocities experienced by the various wavelength components of the optical beam. Because the dispersion curve for glass is downward sloping in the visible portion of the optical spectrum, the red portions of the spectrum experience a reduced index of refraction with respect to the blue portions as the light propagates through prisms 30 and 70. Accordingly, the red components travel through the first prism at a higher velocity than the blue components and reach the color selector at an earlier point in time than the blue components. Thus, the color selector is designed and fabricated to position the various transparent openings as a function of time such that the wavelength components overlapping with a particular transparent opening are passed through the color selector as desired. Additional dispersion is introduced in the second prism 70.

The dispersion experienced by the optical signals as they propagate through the color selector system is utilized to temporally separate the wavelength components generated by the color selector system. In FIG. 2, for example, the optical train emitted to the right of prism 70 is separated into a train of optical signals defined by their wavelength content. The red components of the original beam 20 arrive at the right side of prism before the green and blue components. Thus, the color separation system not only separates the original beam into wavelength selected signals, but temporally separates these signals by the use of dispersion.

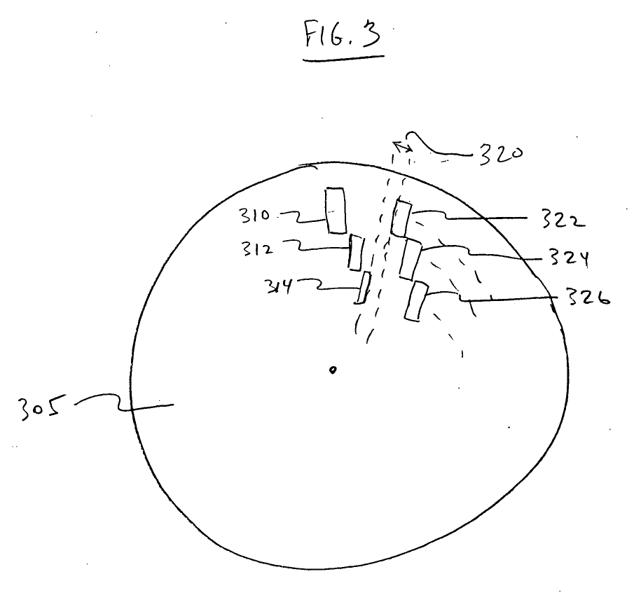

FIG. 3 is a simplified schematic diagram of a wavelength selector disc in accordance with an embodiment according to the present invention. As illustrated in FIG. 3, in an embodiment according to the present invention, the transparent openings in selector disc 305 are repeated in groups of three around the selector disc. The arrangement of the transparent openings is selected in a predetermined fashion to optimize the wavelength coverage and temporal duration of each color. In the embodiment illustrated in FIG. 3, the rightmost portion of transparent opening 314 is separated in circumferential position from the leftmost portion of transparent opening 322 by distance 320. The distance 320 is pre-selected as a function of the rotation rate of the disc 305, the dimensions of the system, and the optical path lengths associated with the wavelength components, among other factors. The distance 320 may be positive or negative. Thus, in this embodiment, the optical delay of various wavelength components with respect to each other is accounted for and the repeated sequence of three colors is continuously output from the color separation system.

Alternative embodiments in accordance with the present invention produce more than three wavelength components. In a specific alternative embodiment according to the present invention, the number of wavelength components is selected to correspond to the number of primary colors utilized in creating display images. For example, the number of primary colors could be four or eight. Other embodiments utilize a larger or smaller number of wavelength components. Moreover, in alternative embodiments according to the present invention, the spectral widths of the wavelength components are non-uniform. For example, in an alternative embodiment, the red wavelength component is 100 nm wide and the green component is 50 nm wide. As will be evident to one of skill in the art, combinations of various numbers of wavelength components, with each component having a pre-selected spectral width, are useful in creating display images of desired quality.

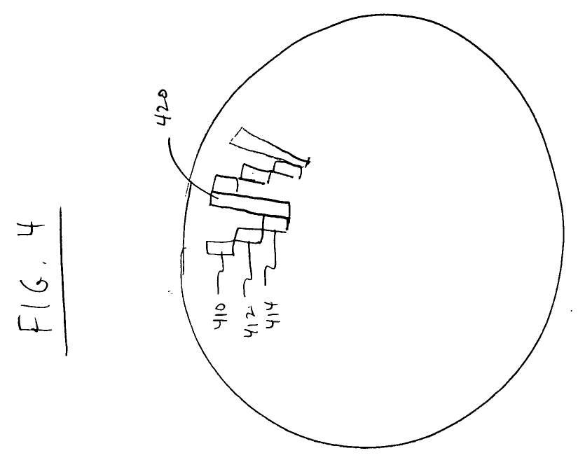

Another alternative embodiment according to the present invention utilizes transparent openings to generate optical signals that are restricted to predetermined wavelength bands as well as optical signals that extend over the entire optical spectrum produced by the illumination source. FIG. 4 is a simplified schematic diagram of a wavelength selector disc according to an alternative embodiment of the present invention. In FIG. 4, the wavelength selector disc has transparent openings 410, 412, and 414 that produce three primary color optical signals over wavelength ranges that are a function of the heights of the various openings. Transparent opening 420 passes all incident light, regardless of the wavelength, creating a “white light” signal as part of the optical train. This clear segment of the optical train is useful in some display applications in which the “white light” segment is used to create brighter whites as well as color shades that are lighter.

In an alternative embodiment according to the present invention, an optically dispersive element other than a prism is used to generate an optical spectrum. For example, in an alternative embodiment according to the present invention, a diffraction grating is utilized in place of a prism. In yet another alternative embodiment, a length of fiber-optical cable is utilized in place of a prism. Combinations of dispersive elements are used in other embodiments according to the present invention.

What is claimed is:

1. A color separation system for generating optical signals for display applications, comprising:
an optical illumination source operative to generate an optical beam;
a first optically refractive element operative to refract the optical beam to produce an optical spectrum;
a selection mechanism operative to separate the optical spectrum into a first optical signal of a first predetermined wavelength range and a second optical signal of a second predetermined wavelength range; and
a second optically refractive element operative to temporally separate the first optical signal and the second optical signal.

2. The color separation system of claim 1 further wherein said selection mechanism is further operative to separate the optical spectrum into a third optical signal of a third predetermined wavelength range.

3. The color separation system of claim 2 wherein the first predetermined wavelength range corresponds to a red region of the optical spectrum, the second predetermined wavelength range corresponds to a green portion of the optical spectrum, and the third predetermined wavelength range corresponds to a blue portion of the optical spectrum.

4. The color separation system of claim 1 wherein the optical spectrum is separated into more than three wavelength ranges.

5. A color separation system for generating optical signals for display applications, comprising:
an optical illumination source operative to generate an optical beam;
a first optically dispersive element to generate an optical spectrum from the optical beam;
a selection mechanism operated to separate the optical spectrum into a plurality of optical signals, each of the plurality of optical signals characterized by a predetermined wavelength range; and
a second optically dispersive element, wherein the plurality of optical signals are temporally separated.

6. The color separation system of claim 5 wherein a first of the plurality of optical signals extends over a first wavelength range greater than a second of the plurality of optical signals.

7. The color separation system of claim 6 wherein the first of the plurality of optical signals is a white light signal.

8. A method of generating optical signals for display applications comprising the steps of:
illuminating a first spectral dispersion element with a beam of light from a multispectral light source;
passing the beam of light through the first spectral dispersion element to produce a spatially dispersed optical spectrum;
separating the optical spectrum into a plurality of spectral components;
selecting a plurality of sub-beams from the plurality of spectral components;
passing the plurality of sub-beams through a second spectral dispersion element; and
generating from the sub-beams a plurality of temporal signals corresponding to said sub-beams.

9. The method of claim 8 wherein a first of the spectral components corresponds to a red region of the optical spectrum, a second of the spectral components corresponds to a green portion of the optical spectrum, and a third of the spectral components corresponds to a blue portion of the optical spectrum.

10. The method of claim 8 wherein said plurality of temporal signals is a train of optical pulses.
